(19) United States
(12) Patent Application Publication
(10) Pub. No.: US 2005/0206838 A1
(43) Pub. Date: Sep. 22, 2005

(54) Auxiliary eyeglasses with two aligned springs for biasing two lens units to move relative to each other

(76) Inventor: Sheng-Tang Chow, Taipei City (TW)

Correspondence Address: FROMMER LAWRENCE & HAUG, 745 FIFTH AVENUE- 10TH FL., NEW YORK, NY, 10151, US

(21) Appl. No.: 10/884,056

(22) Filed: Jul. 2, 2004

(30) Foreign Application Priority Data
Mar. 18, 2004 (TW) 093204111

(51) Int. Cl. G02C 7/16; G02C 5/02

(52) U.S. Cl. 351/124

(57) ABSTRACT

A pair of auxiliary eyeglasses is attached to a pair of primary eyeglasses, and has a bridge including a rigid connecting tube that is disposed between two lens units. Two movable rods are connected respectively to the lens units, extend respectively through two open ends of the connecting tube, are movable within the connecting tube, and engage respectively and fittingly the non-circular holes in the inward flanges so as to prevent rotation of the movable rods relative to the connecting tube. The auxiliary eyeglasses further include two coiled compression springs, each of which is disposed between the outward flange of a respective one of the movable rods and a respective one of the inward flanges of the connecting tube so as to bias the movable rods to move toward each other.

### CROSS-REFERENCE TO RELATED APPLICATION

This application claims priority of Taiwanese Application No. 093204111, filed on Mar. 18, 2004.

### BACKGROUND OF THE INVENTION

1. Field of the Invention

This invention relates to a pair of auxiliary eyeglasses disposed on and in front of a pair of primary eyeglasses, and more particularly to a pair of auxiliary eyeglasses that includes two aligned springs for biasing two lens units to move toward each other.

2. Description of the Related Art

Referring to FIGS. 1, 2, and 3, a pair of first conventional auxiliary eyeglass 11 is shown to include two lens units 111, four retaining hooks 112, and a bridge 113. The lens units 111 are retained on a lens unit 121 of a pair of primary eyeglasses 12 by the retaining hooks 112. The bridge 113 has two ends that are connected respectively and fixedly to the lens units 111. Because the length of the bridge 113 is fixed, the first conventional auxiliary glasses 11 is not suitable for other primary eyeglasses of different sizes.

Referring to FIGS. 4, 5, and 6, a pair of second conventional auxiliary eyeglasses 2 is shown to include: two lens units 21; two retaining units disposed respectively on the lens units 21, each of the retaining units including a pair of upper and lower retaining hooks 22, 22′; and a bridge 23 having a variable length so as to solve the above-mentioned problem of the first conventional auxiliary eyeglasses 11. The bridge 23 includes a fixed seat 231 connected fixedly to the left lens unit 21, a movable rod 232 connected fixedly to the right lens unit 21, a coiled compression spring 233 sleeved on the movable rod 232, a U-shaped rod 234 connected fixedly to the fixed seat 231, a fixed plate 235 connected fixedly to the U-shaped rod 234, and a movable plate 236 connected fixedly to the movable rod 232 and movable relative to the U-shaped rod 234. The movable rod 232 extends through the fixed plate 235. The spring 233 is disposed between the fixed plate 235 and the movable plate 236 so as to bias the movable plate 236 to move away from the fixed plate 235, thereby urging the lens units 21 toward each other. During assembly, the lens units 21 are pulled away from each other so as to permit each lens unit 31 of a pair of primary eyeglasses 3 to be disposed between the upper and lower retaining hooks 22, 22′ of the corresponding retaining unit. Subsequently, the second conventional auxiliary eyeglasses 2 are released so that the lens units 31 of the primary eyeglasses 3 can be clamped between the retaining units, thereby retaining the second conventional auxiliary eyeglasses 2 on the primary eyeglasses 3. The second conventional auxiliary eyeglasses 2 are disadvantageous in that the bridge 23 has a relatively large size. Furthermore, the structure of the bridge 3 will affect adversely the appearance of the second conventional auxiliary eyeglasses 2.

U.S. Pat. Nos. 6,234,628 and 6,302,538 disclose a coiled spring that is concealed within a cylindrical enclosure. Thus, the appearance of the eyeglasses is enhanced. Two bridge elements extend respectively into two ends of the cylindrical enclosure, and each have a protrusion that engages a slot in the cylindrical enclosure so as to prevent relative rotation therebetween. However, small external articles may enter into the cylindrical enclosure through the slot to thereby affect the biasing function of the coiled spring. In addition, the hair of the eyeglasses wearer may also enter into the cylindrical enclosure through the slot. In this case, the hair of the wearer may be clamped between the cylindrical enclosure and the coiled spring, thereby hurting the wearer.

### SUMMARY OF THE INVENTION

The object of this invention is to provide a pair of auxiliary glasses that can overcome the above-mentioned disadvantages associated with the prior art.

According to this invention, a pair of auxiliary eyeglasses adapted to be disposed on and in front of a pair of primary eyeglasses. The auxiliary eyeglasses include two lens units, two retaining units connected respectively to the lens units and adapted to be attached to the primary eyeglasses, and a bridge. The bridge includes a rigid connecting tube disposed between the lens units and having two open ends, and two inward flanges extending respectively, radially, and inwardly from the open ends of the connecting tube to define a non-circular hole. Two movable rods are connected fixedly to the lens units, extend respectively through the open ends of the connecting tube, are movable within the connecting tube, and engage respectively and fittingly the non-circular holes in the inward flanges so as to prevent rotation of the movable rods relative to the connecting tube. Each of the movable rods has an inner end that is formed with an outward flange extending radially and outwardly therefrom. The auxiliary eyeglasses further have two coiled compression springs, each of which is disposed between the outward flange of a respective one of the movable rods and a respective one of the inward flanges of the connecting tube so as to bias the movable rods to move toward each other and so as to bias the lens units of the auxiliary eyeglasses toward each other, thereby clamping the primary eyeglasses between the retaining units.

Because the diameter of the connecting tube is relatively small, the size of the bridge is reduced. Furthermore, the springs are concealed within the connecting tube so as not to mar the appearance of the auxiliary eyeglasses. No slot is formed in the connecting tube so as to prevent the hair of the eyeglasses or small external articles from entering into the connecting tube.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a side view of a pair of first conventional auxiliary eyeglasses disposed on and in front of a pair of primary eyeglasses;

FIG. 2 is a side view of the first conventional auxiliary eyeglasses that is removed from the primary eyeglasses;

FIG. 3 is a perspective view of the first conventional auxiliary eyeglasses;

FIG. 4 is a perspective view of a pair of second conventional auxiliary eyeglasses that is removed from a pair of primary eyeglasses;

FIG. 5 is a top view of the second conventional auxiliary eyeglasses that are removed from the primary eyeglasses;

FIG. 6 is a top view of the second conventional auxiliary eyeglasses disposed on the primary eyeglasses;

FIG. 7 is a partly sectional front view of the first preferred embodiment of a pair of auxiliary eyeglasses according to this invention;

FIG. 7A is a fragmentary sectional view of a connecting tube of the first preferred embodiment;

FIG. 8 is a partly sectional front view of the first preferred embodiment, illustrating how two lens units are pulled away from each other so that the first preferred embodiment is ready for connection with a pair of primary eyeglasses;

FIG. 9 is a partly sectional top view of the first preferred embodiment, illustrating how the first preferred embodiment is connected to the primary eyeglasses;

FIG. 10 is a front view of the first preferred embodiment, illustrating two modified lens units;

FIG. 11 is a sectional view of the first preferred embodiment taken along Line XI-XI in FIG. 9;

FIG. 12 is a schematic top view of the second preferred embodiment of a pair of auxiliary eyeglasses according to this invention;

FIG. 13 is a schematic front view of the second preferred embodiment;

FIG. 14 is a schematic front view of the second preferred embodiment, illustrating how two lens unit are pulled away from each other so that the second preferred embodiment is ready for connection with a pair of primary eyeglasses;

FIG. 15 is a schematic top view of the third preferred embodiment of a pair of auxiliary eyeglasses according to this invention;

FIG. 16 is a schematic front view of the third preferred embodiment;

FIG. 17 is a fragmentary, schematic front view of the third preferred embodiment, illustrating how two lens units are pulled away from each other so that the third preferred embodiment is ready for connection with a pair of primary eyeglasses; and

FIG. 18 is a top view of the third preferred embodiment, illustrating how the preferred embodiment is folded to form a compact unit.

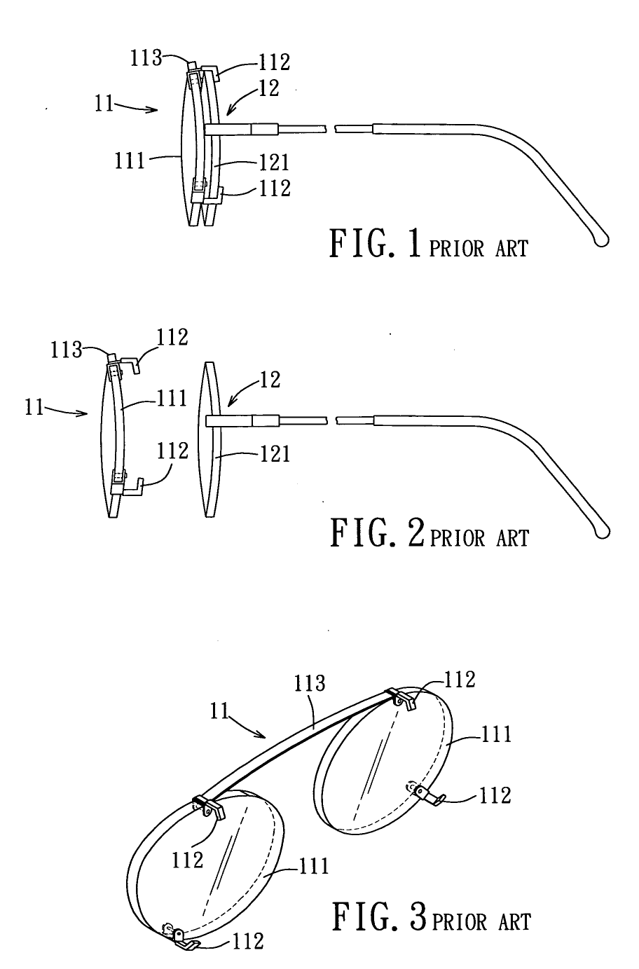

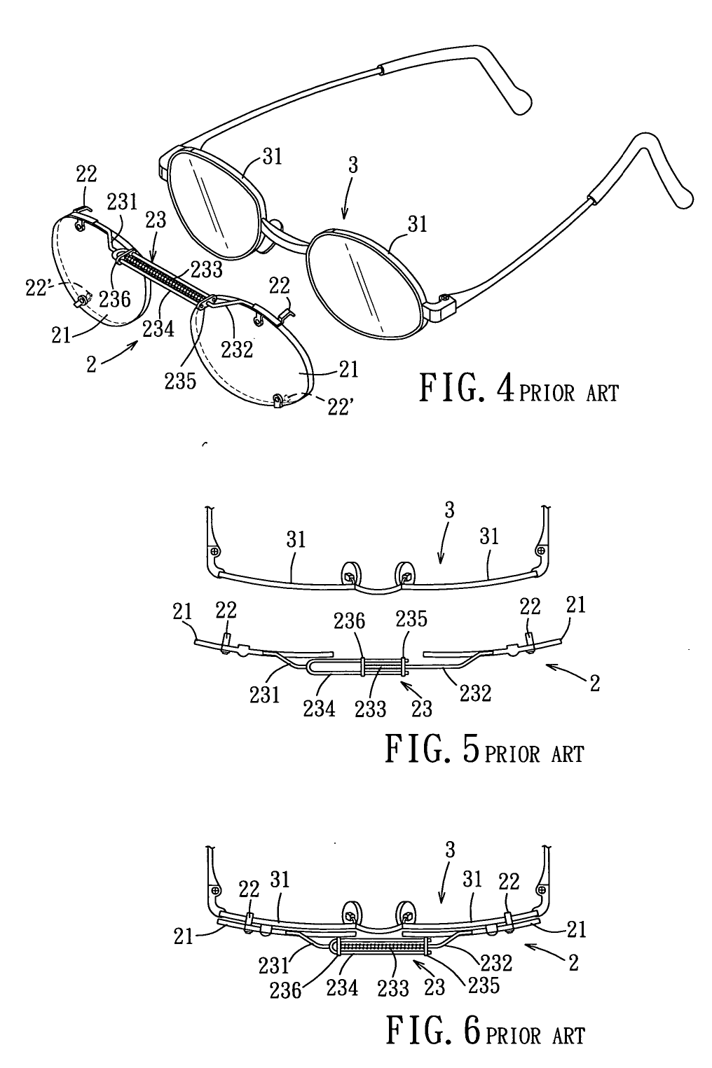

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

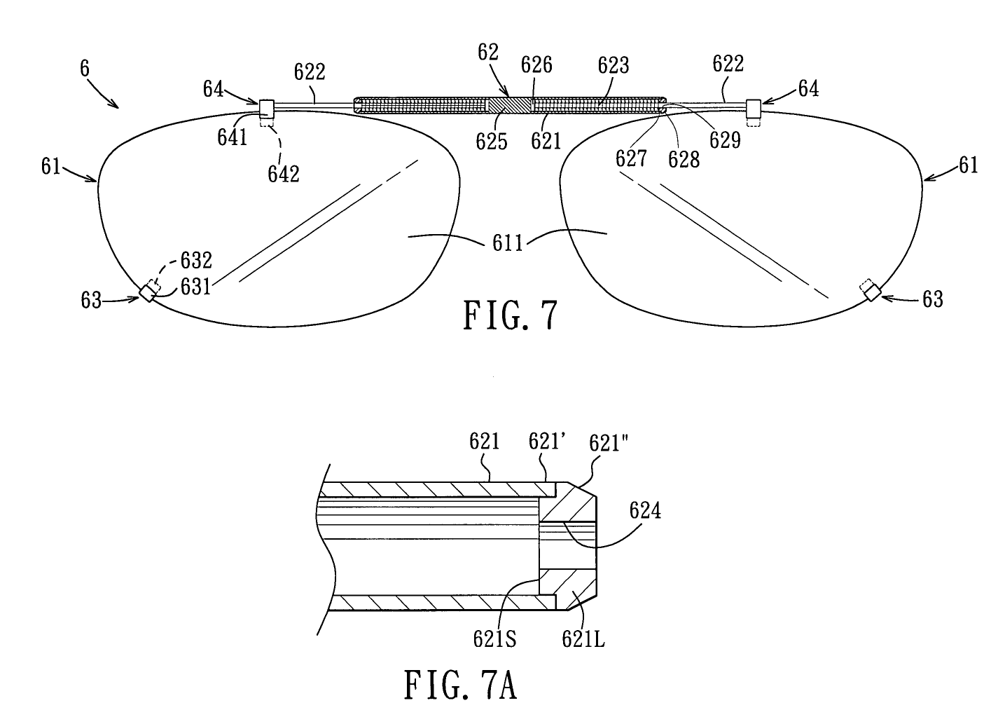

Referring to FIG. 7, the first preferred embodiment of a pair of frameless auxiliary eyeglasses 6 according to this invention is shown to include two lens units 61, a bridge 62, and two retaining units, each of which has a lower retaining member 63 and an upper retaining member 64. The auxiliary eyeglasses 6 are adapted to be disposed on and in front of a pair of primary eyeglasses 7 (see FIG. 9) that includes two lens units 71, a bridge 72, and two temples 73. Each of the lens units 61 includes a lens 611. The lower and upper retaining members 63, 64 of each of the retaining units are connected to the corresponding lens unit 61 in a known manner, and are adapted to be attached to the corresponding lens unit 71 of the primary eyeglasses 7. Each of the lower retaining members 63 has a clamping portion 631 and a hook portion 632. Each of the upper retaining members 64 has a retaining portion 641 and a clamping portion 642.

The bridge 62 includes a rigid connecting tube 621, two movable rods 622, and two coiled compression springs 623. The connecting tube 621 is disposed between the lens units 61, and has two open ends, two inward flanges 624 (see FIG. 7A) extending respectively, radially, and inwardly from the open ends of the connecting tube 621, and a spacer 625 disposed within a middle portion of the connecting tube 621 between the movable rods 622. The movable rods 622 extend respectively through the open ends of the connecting tube 621, and are movable within the connecting tube 621. Each of the movable rods 622 has an inner end that is formed with an outward flange 626 extending radially and outwardly therefrom. Each of the springs 623 is disposed between the outward flange 626 of the corresponding movable rod 622 and the corresponding inward flange 624 of the connecting tube 621 so as to bias the movable rods 622 toward each other.

Referring to FIG. 7A, the connecting tube 621 has a tube body 621′ having two open ends, and two tubular end plugs 621″ (only one is shown) that are inserted respectively into and that are fixed respectively within the ends of the tube body 621′, and that define the inward flanges 624. Each of the end plugs 621″ has a uniform inner diameter, a small-diameter inner portion (621S) that is disposed within the connecting tube 621, and a large-diameter outer portion (621L) that has an outer diameter larger than that of the small-diameter inner portion (621S) and that abuts against an end surface of the tube body 621′.

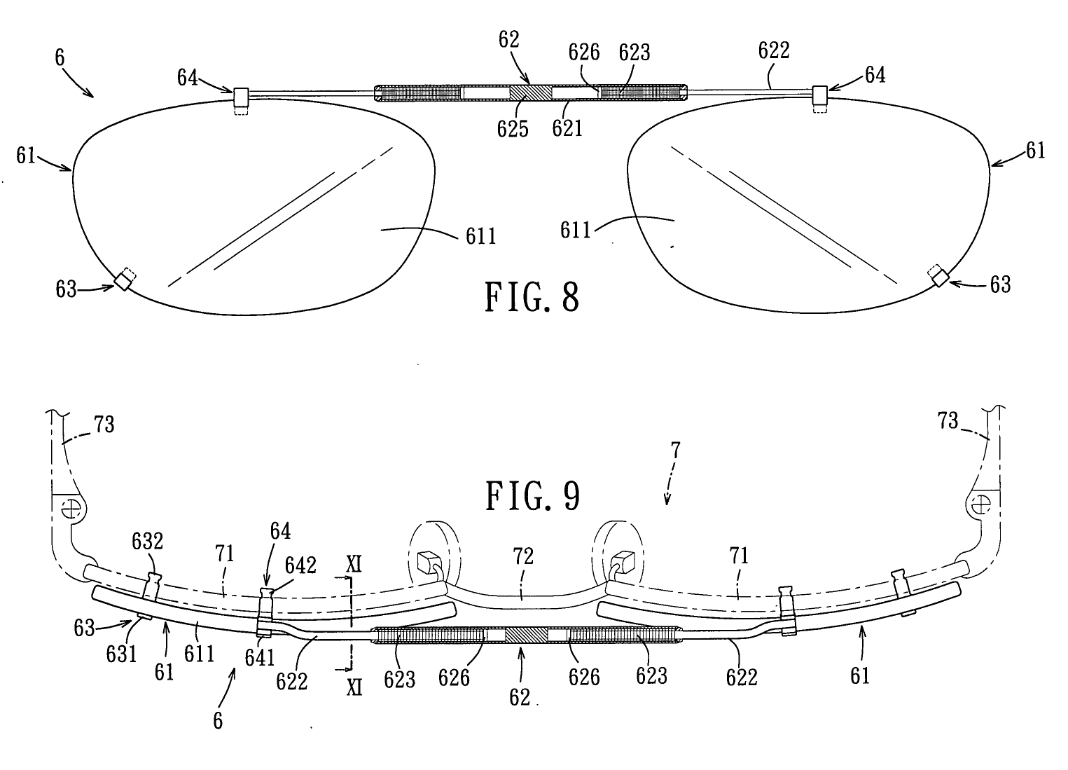

During assembly, the lens units 61 of the auxiliary eyeglasses 6 are pulled away from each other, as shown in FIG. 8, so as to permit the upper and lower retaining members 64, 63 to engage the lens units 71 of the primary eyeglasses 7, respectively. Thereafter, the auxiliary eyeglasses 6 are released so that the lens units 61 of the auxiliary eyeglasses 6 move toward each other by a small distance, thereby clamping the lens units 71 of the primary eyeglasses 7 between the retaining units, as shown in FIG. 9.

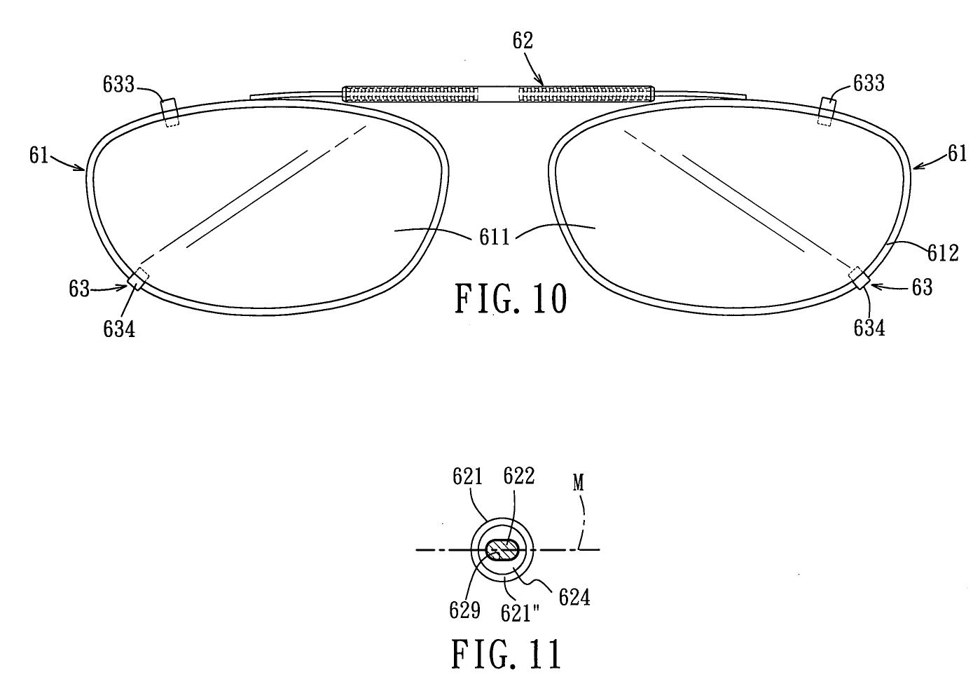

Referring to FIG. 10, the frameless auxiliary eyeglasses 6 can be modified into framed ones. That is, each of the lens units 61 includes a lens 611 and a lens frame 612, within which the lens 611 is disposed.

Referring to FIG. 11, each of the inward flanges 624 of the connecting tube 621 defines an elliptical hole 629 that has a horizontal major axis (M). The movable rods 622 have an elliptical cross-section, and engage respectively and fittingly within the elliptical holes 629 in the inward flanges 624 of the connecting tube 621 so as to prevent rotation of the movable rods 622 relative to the connecting tube 621. The holes 629 and the cross-section of the movable rods 622 may be of any other suitable non-circular shape, such as star, rectangle, or triangle.

The auxiliary eyeglasses 6 of this invention have the following advantages:
(1) Because the diameter of the connecting tube 62 is relatively small, the size of the auxiliary eyeglasses 6 is reduced.
(2) The springs 623 are concealed within the connecting tube 621 so as not to mar the appearance of the auxiliary eyeglasses 6.
(3) No slot is formed in the connecting tube 621. Therefore, the above-mentioned disadvantages of U.S. Pat. Nos. 6,234,628 and 6,302,538 are obviated.

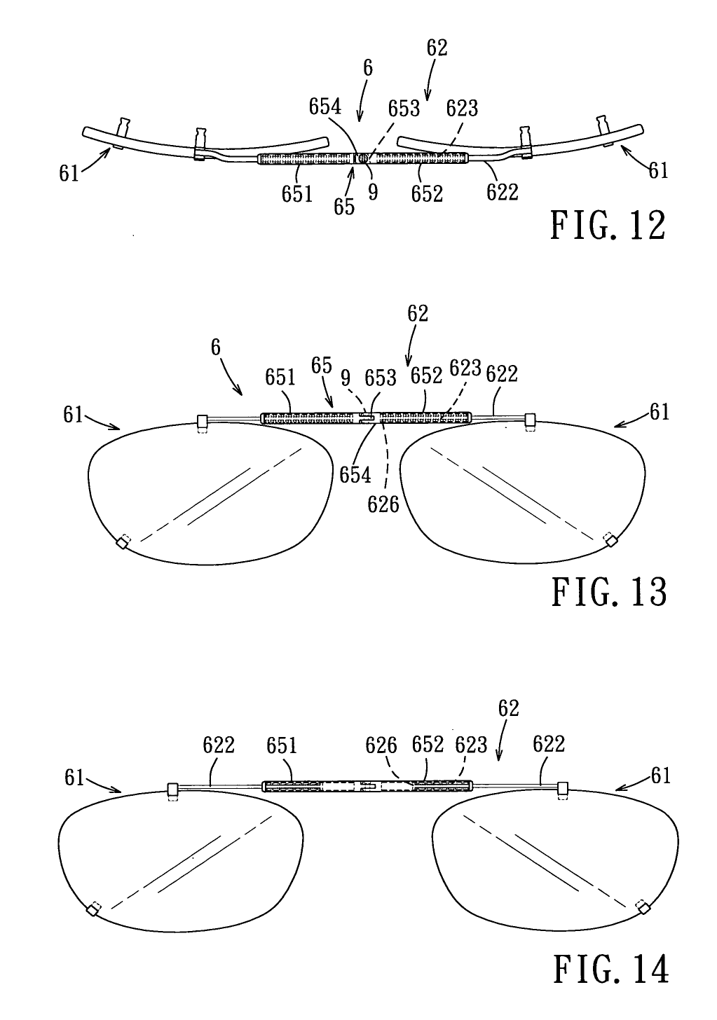

FIGS. 12, 13, and 14 show a modified bridge 62, which is similar to that of the first preferred embodiment in construction. Unlike the first preferred embodiment, the connecting tube 65 includes a pair of first and second tube bodies 651, 652 that are aligned with and that are connected rotatably to each other by a pivot pin 9. The movable rods 622 extend respectively into the first and second tube bodies 651, 652. In this embodiment, the bridge 62 is not provided with the spacer 625 (see FIG. 7). As such, the connecting tube 65 is foldable.

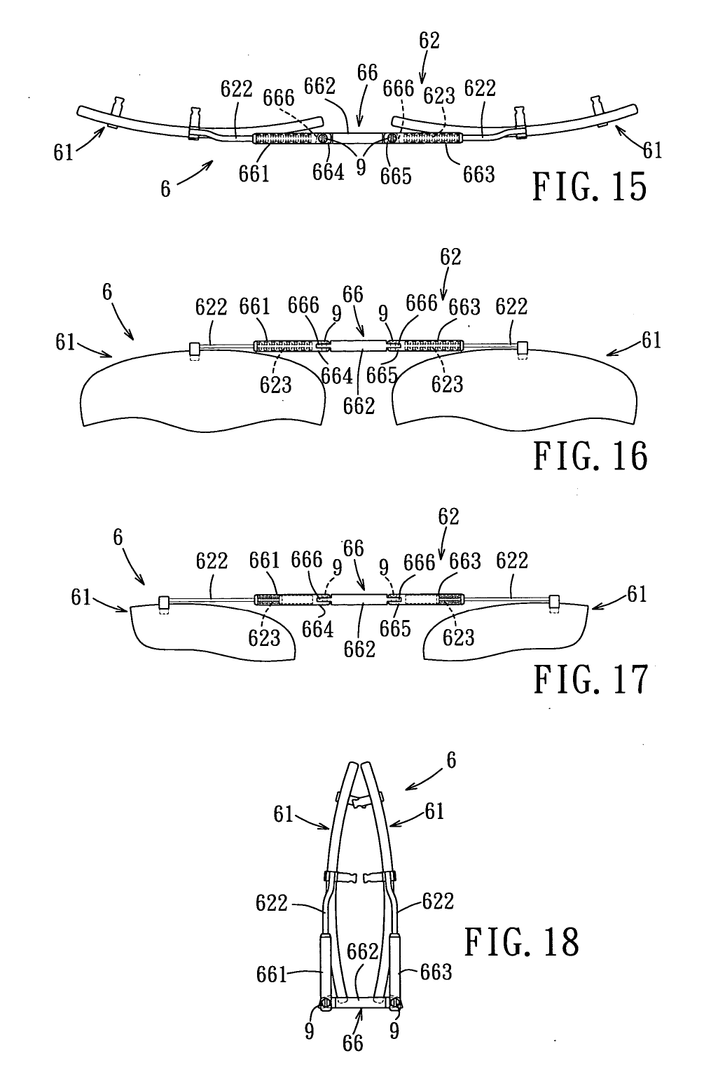

FIGS. 15, 16, 17, and 18 show another modified bridge 62, which is similar to the first preferred embodiment in construction. Unlike the first preferred embodiment, the connecting tube 66 includes two end tube bodies 661, 663 and a middle tube body 662 that is disposed between and that is aligned with the end tube bodies 661, 663. The movable rods 622 extend respectively into the end tube bodies 661, 663. The middle tube body 662 has two ends that are connected respectively and rotatably to the end tube bodies 661, 663 by two pins 9 such that the end tube bodies 661, 663 are rotatable relative to the middle tube body 662 toward each other, as shown in FIG. 18. As such, the connecting tube 66 is foldable to form a compact unit. In this embodiment, there is also no need for the spacer 625 (see FIG. 7) within the connecting tube 66.

With this invention thus explained, it is apparent that numerous modifications and variations can be made without departing from the scope and spirit of this invention. It is therefore intended that this invention be limited only as indicated by the appended claims.

1. A pair of auxiliary eyeglasses adapted to be disposed on and in front of a pair of primary eyeglasses, the primary eyeglasses having two lens units, said auxiliary eyeglasses comprising:
two lens units;
two retaining units connected respectively to said lens units of said auxiliary eyeglasses and adapted to be attached to the primary eyeglasses; and
a bridge including
a rigid connecting tube disposed between said lens units of said auxiliary eyeglasses and having two open ends, and two inward flanges extending respectively, radially, and inwardly from said open ends of said connecting tube, each of said inward flanges of said connecting tube defining a non-circular hole therein,
two movable rods extending respectively through said open ends of said connecting tube and movable within said connecting tube, each of said movable rods having an inner end that is formed with an outward flange extending radially and outwardly therefrom, said movable rods having a uniform cross-section and engaging respectively and fittingly said non-circular holes in said inward flanges of said connecting tube so as to prevent rotation of said movable rods relative to said connecting tube, and
two coiled compression springs, each of which is disposed between said outward flange of a respective one of said movable rods and a respective one of said inward flanges of said connecting tube so as to bias said movable rods to move toward each other and so as to bias said lens units of said auxiliary eyeglasses toward each other, thereby clamping the lens units of the primary eyeglasses between said retaining units,
wherein said connecting tube includes a tube body having two open ends, and two tubular end plugs that are inserted respectively into and that are fixed respectively within said ends of said tube body and that define respectively said inward flanges.

2. The pair of auxiliary eyeglasses as claimed in claim 1, wherein each of said lens units of said auxiliary eyeglasses includes a lens.

3. The pair of auxiliary eyeglasses as claimed in claim 1, wherein each of said lens units of said auxiliary eyeglasses includes a lens frame and a lens disposed within said frame.

4. The pair of auxiliary eyeglasses as claimed in claim 1, wherein said connecting tube includes a pair of first and second tube bodies that are aligned with and that are connected pivotally to each other, said movable rods extending respectively into said first and second tube bodies.

5. The pair of auxiliary eyeglasses as claimed in claim 1, wherein said connecting tube includes two end tube bodies and a middle tube body that is disposed between and that is aligned with said end tube bodies, said movable rods extending respectively into said end tube bodies, said middle tube body having two ends that are connected respectively and pivotally to said end tube bodies such that said end tube bodies are rotatable relative to said middle tube body toward each other.

6. The pair of auxiliary eyeglasses as claimed in claim 1, wherein each of said non-circular holes in said inward flanges of said connecting tube is shaped as an elliptical hole that has a horizontal major axis.

7. The pair of auxiliary eyeglasses as claimed in claim 1, wherein said tube body has two opposite end surfaces, each of said end plugs having a uniform inner diameter, a small-diameter inner portion that is disposed within said tube body, and a large-diameter outer portion that has an outer diameter larger than that of said small-diameter inner portion and that abuts against a corresponding one of said end surfaces of said tube body.

8. The pair of auxiliary eyeglasses as claimed in claim 1, wherein said tube body has two opposite end surfaces, each of said end plugs having a uniform inner diameter, a small-diameter inner portion that is disposed within said tube body, and a large-diameter outer portion that has an outer diameter larger than that of said small-diameter inner portion and that abuts against a corresponding one of said end surfaces of said tube body.
